(19) United States
(12) Patent Application Publication
(10) Pub. No.: US 2025/0382740 A1
(43) Pub. Date: Dec. 18, 2025

(54) METHOD AND APPARATUS FOR FEEDING RECTANGULAR TEXTILE ARTICLES TO AN INTAKE DEVICE

(71) Applicant: Herbert Kannegiesser GmbH, Vlotho (DE)

(72) Inventors: Engelbert HEINZ, Vlotho (DE); Markus NOLTE, Hille (DE); Martin GREBER, Rostock (DE); Andreas RICHTER, Rostock (DE)

(73) Assignee: Herbert Kannegiesser GmbH, Vlotho (DE)

(21) Appl. No.: 19/239,493

(22) Filed: Jun. 16, 2025

(30) Foreign Application Priority Data
Jun. 18, 2024 (DE) 10 2024 117 155.3

(51) Int. Cl. D06F 95/00; B25J 9/16; B25J 11/00

(52) U.S. Cl. CPC D06F 95/00; B25J 9/1679; B25J 9/1697; B25J 11/008

(57) ABSTRACT

A method and apparatus for rapidly and reliably feeding textile articles automatically to an intake device wherein, in order to automatically feed rectangular textile articles to an intake device, the separated textile articles are gripped on a portion of an edge. Subsequently, the textile article is pulled on over a conveyor, in order to transport the article to a processing device. To this end, the textile article is first of all fed in a hanging manner in a clamp on a corner region to a pull-on position, and an upper loop of the hanging textile article is determined in this pull-on position. This upper loop of the article is gripped by a gripper and the textile article hanging on the clamp is stretched. The gripper and the clamp pull the textile article, which is stretched or is to be stretched, in a synchronized movement over the conveyor.

The invention relates to a method for feeding a rectangular textile article in accordance with the preamble of claim 1. Furthermore, the invention relates to an apparatus for gripping rectangular textile articles in accordance with the preamble of claim 14.

Textile articles, in particular laundry items which are to be washed and/or are washed, with a rectangular design have to be gripped in such a way that they can be fed to an intake device or a treatment device for further processing. This applies, in particular, to rectangular textile articles which have edges which are of the same length or of different lengths and run at a right angle with respect to one another. In particular, the handling of square laundry items proves to be very complicated, since the detection of the corner regions which are preferably to be gripped is difficult.

The intention is to automatically grip rectangular textile articles and to feed them automatically to an intake device. It has been shown, however, that this has been time-consuming and unreliable up to now. In particular, gripping the textile article with a gripper requires that the textile article is oriented correspondingly and a suitable location is available, on which the gripper can act. The detection of a preferred position for gripping the laundry item also proves to be very complicated, since the articles as a rule assume almost any shape, and suitable positions for gripping are to be determined from this wide variety of shapes.

The invention is based on the object of providing a method and an apparatus for rapidly and reliably feeding textile articles automatically to an intake device.

A method for achieving the object has the measures of claim 1. It is accordingly provided for automatically feeding rectangular textile articles, in particular laundry items, preferably sheets, tablecloths or the like, to an intake device, that the separated textile articles are gripped on a portion of an edge. Subsequently, the textile article is pulled on over a conveyor in order to transport the article to a processing device. To this end, the textile article is first of all fed in a hanging manner in a clamp on a corner region, in particular on a corner, to a pull-on position, and an upper loop of the hanging textile article is determined in this pull-on position. This upper loop of the article is gripped by a gripper, and the textile article hanging on the clamp is stretched. The gripper and the clamp pull the textile article which is stretched or is to be stretched in a synchronized movement over the conveyor. By virtue of the fact that, at the beginning of this method, the article hangs on the clamp on a corner region or a corner, an adjacent corner region or an adjacent corner is configured directly below the corner region which hangs in the clamp. This corner region which hangs down forms the loop which can be determined particularly satisfactorily as a loop of this type and can be gripped by the gripper. During the described method, releasing or clasping of a gripper or a clamp is not necessary. As soon as it has been gripped by the clamp and the gripper, the article is guided in this gripped state as far as the conveyor. Merely one gripping process is therefore necessary for this method. At the beginning of the method or before the method, the article is guided into the clamp manually or by a further automatic operation which is not described in greater detail here. As a result of this highly time-efficient and simple method, the complicated intermediate steps up to now can be dispensed with. Moreover, square textile articles or laundry items can also be handled, in particular, by this method.

The method preferably provides that one or more spaced apart textile articles are fed to the pull-on position in a hanging manner on a transport system, preferably a rail system or a gripper of a robot arm. Here, a multiplicity of clamps are fed automatically to the pull-on position in the rail system at a sufficient spacing from one another. Here, the transport system or the rail system can be configured in such a way that the speed of the clamps is variable, and/or that the movement of the clamps can be stopped or even turned. A transport system is conceivable, in which two or more rail systems run parallel to one another and therefore the number of laundry items which can be transported to the pull-on position can be increased. Since a rail system can be provided in a highly compact manner, the method described herein can be carried out in a highly space-saving manner.

The invention provides, in particular, that the textile article is recorded by one or two or more cameras, preferably a 3D camera, in particular from different directions, and the upper loop of the hanging article is determined, an algorithm for pattern detection being used to this end, in particular. For the case where the article is oriented in such a way that no loop can be detected from a certain direction, it can be advantageous if a second camera is positioned in such a way that a region which cannot be seen by the other camera is covered. Moreover, it is conceivable that an at least approximately three-dimensional image of the article can be generated by two or more cameras, with the result that a position for gripping the article by the gripper can be determined in an even more reliable way. As an alternative or in addition, it is conceivable that the article is mounted rotatably, with the result that a second recording of the article can be generated by the one or more cameras after a rotation, in order to determine a particularly suitable position for gripping the article. A neural network or a pattern detection means based on artificial intelligence can be used for the determination of this position. The article can be gripped particularly reliably as a result of the use of this learning pattern detection means. The processor for carrying out this detection can be a constituent part of the machine or can be installed in a decentralized manner on an external server.

Accordingly, the invention can provide that, for the case where no upper loop is detected by the camera, the article or the clamp, in particular the clamp hanging in the rail, is preferably rotated about a horizontal axis of the article by ±45°, ±90° or ±180°, until an upper loop is detected. One advantage of the exemplary embodiment can provide that the article is turned in a stepped manner by an angular range, for example 45°, and a check is carried out after each partial rotation as to whether a loop can be detected. If a loop is detected, it can also be determined whether this loop is suitable for being gripped by the gripper. Here, the instantaneous position of the gripper is also taken into consideration. If gripping would be too time-consuming on account of the relative positioning of the loop and the gripper, it is conceivable that the laundry item is turned even further.

One particularly preferred exemplary embodiment of the invention provides that the gripper is moved automatically by a robot arm onto the loop to be gripped. Here, the robot with the robot arm, or the robot arm is situated in the vicinity of the transport system or the rail. For the case where two rail systems are provided, the robot arm is situated between these two rails, with the result that each rail can be handled by the robot arm and the gripper in an alternating manner and/or in a time-efficient way. The robot arm is a multiaxial arm which can position itself or the gripper in three-dimensional space. The robot arm preferably has six axes with corresponding actuators. Via a control unit, this robot arm including the gripper can be controlled in a manner dependent on the determined position for gripping the article. Here, the gripper is configured as a simple gripper with a simple gripping jaw. This has the advantage in comparison with a gripper with two gripping jaws that a smaller edge region is sufficient to grip the laundry item.

One particularly preferred step of the invention consists in that the robot arm with the gripper carries out a movement which stretches the article, the movement taking place in such a way that two edges or borders of the article are oriented at least approximately parallel to one another. Here, the gripped article is moved on a circular path by the gripper, the radius of this circular path being formed by the spacing between the clamp and the gripper. This pivoting movement of the gripper takes place counter to the transport direction of the article. By virtue of the fact that the article is already gripped by the clamp by way of a corner region and the upper loop is gripped by the gripper, the article is gripped on two adjacent regions. As a result of the stretching of the article, the article hangs downward on the clamp and the gripper in such a way that two opposite sides or edges of the article are oriented parallel to one another. During the stretching movement, the gripper moves on a spherical envelope around the clamp or around that region of the article which is gripped by the clamp. The radius of the spherical envelope corresponds precisely to the spacing between the clamp and the gripper. Keeping the spacing constant avoids the laundry item being torn out of the clamp or the gripper. This movement likewise guarantees that the article is stretched in such a way that the two opposite edges are oriented in parallel and the article hangs downwards in a stretched manner without developing folds in the process.

Furthermore, it is preferably provided that the article is stretched by the robot arm with the gripper parallel to a transport direction of the conveyor into a stretched state, the two at least approximately parallel edges or borders being oriented transversely, in particular perpendicularly, and a lower border or a lower edge of the article being oriented at least approximately parallel to the transport direction of the conveyor. As a result of the stretching movement of the gripper, the article or the sheet is moved into a position, from which it can be deposited over the conveyor in a simple and, above all, reliable way.

As an alternative, it is preferably provided that the article is stretched by the robot arm with the gripper parallel to a transport direction of the conveyor into a stretched state, while the clamp is already moved on a linear axle in the direction of the conveyor and, during this movement, the two edges are oriented at least approximately parallel to one another and transversely, in particular perpendicularly, and a lower edge is oriented at least approximately parallel to the transport direction of the conveyor. In the case of this movement of the clamp which is already to be moved toward the conveyor, the gripper is always moved in such a way that the spacing between the clamp and the gripper never exceeds the radius of the completed circular path. As a result of this combined stretching and downward movement, a particularly time-efficient method can be realized. It is conceivable that the clamp is transferred from the rail system to the linear axle. The linear axle likewise has drives, in order to move the clamp at a defined speed in the direction of the conveyor. Here, the linear axle is preferably oriented obliquely and leads transversely beyond the conveyor.

Furthermore, it is preferably provided that the article is deposited from the stretched state by the clamp and the gripper over the conveyor, the clamp being moved on a linear axle and the gripper being moved by the robot arm without the relative position between the clamp and the gripper being changed. The spacing between the clamp and the gripper is ideally always the radius of the circular movement or the spherical envelope or the spacing between the clamp and the gripper at the time the article is gripped. In the case of this downward leading movement, an imaginary distance between the clamp and the gripper is positioned parallel to the conveyor. Therefore, the article is guided in parallel beyond the conveyor and deposited on the latter.

It is provided, in particular, that the clamp and the gripper release the article as soon as a center of one of the edges, preferably of the longer edge, lies above the conveyor. If the article is released in this position, it falls in a particularly preferred position over the conveyor, with the result that the latter can convey the article to a further treatment device.

In particular, the invention can provide that articles which hang on clamps on two transport systems, preferably two parallel rail systems, are gripped in a temporally offset manner by at least one, preferably the same, gripper and are deposited from opposite sides of the conveyor over the latter in the described way. Here, the gripper is provided, in particular, by the robot arm in an alternating manner on the opposite rail systems, with the result that articles which hang on different rail systems can be stretched and deposited in an alternating manner.

It is also conceivable that the clamps on the two transport systems, preferably the two parallel rails, move in a completely asynchronous manner with respect to one another, the movement of the clamps depending on the recording of the cameras and/or on whether articles hang on the clamps or not and/or on the inherent movement of the articles.

An apparatus for achieving the object stated at the outset has the features of claim 14. Accordingly, it is provided that the apparatus is configured, in particular, in such a way that it can carry out the method as claimed in claim 1. This apparatus for feeding rectangular textile articles, in particular laundry items, preferably sheets, tablecloths or the like, is distinguished by a transport system which has at least one rail or at least one robot and on which the clamp can be moved in order to convey the textile articles to a pull-on position. Moreover, this apparatus has at least one gripping system with a gripper for gripping a loop of the textile article in a targeted manner and for stretching and pulling on the article. Furthermore, the apparatus has a camera system for determining the loop. The clamp and the gripper can be moved in a synchronized manner, the clamp moving during this movement along a linear axle which is part of the apparatus. In the case of this synchronized movement, the article which is stretched or is to be stretched is situated between the clamp and the gripper. The textile article is stretched and fed to a conveyor in a way which is highly simple and therefore time-efficient but also reliable by this apparatus with the use of a clamp and a gripper which are assigned to a rail system or a gripping system, with the result that the article can be fed directly to a further treatment device.

One particularly preferred exemplary embodiment of the invention provides, furthermore, that the article hanging on the clamp is recorded by at least one, two or more cameras, preferably a 3D camera. To this end, the one camera or the cameras is/are positioned directly next to the rail, with the result that a sufficiently precise image of the laundry item can be achieved. The at least one camera is to be positioned relative to the article in such a way that it sees the potential position of the loop. As an alternative to the use of a plurality of cameras, it is conceivable that the clamp is arranged on a rotatable carriage which can be rotated if a suitable position for gripping the article cannot be determined by the at least one camera. The image detection can take place in this method according to the invention via a control system or a processor which is assigned directly to the apparatus or is installed centrally on a server.

In addition, the invention can provide that the clamp which hangs in the rail is mounted rotatably by ±45°, ±90° or ±180°, and the rotation takes place automatically or on the basis of a changing friction or a braking operation. The rail system and the clamp are configured in such a way that they can be actuated by the control system and their movement can be influenced. To this end, the rail system can be assigned actuators which manipulate the movement of the carriages in a targeted manner.

A further advantageous exemplary embodiment of the invention can provide that the gripper is arranged on a robot arm, preferably in order to carry out a movement in three-dimensional space, and this robot arm is assigned to one, two or more rail systems. Finally, it is conceivable according to the invention that the robot arm is arranged between two rail systems, with the result that the robot arm can operate the two rails in an alternating manner and can grip and stretch, in an alternating manner, the textile articles which hang on different rail systems.

One preferred exemplary embodiment of the invention will be explained in greater detail in the following text on the basis of the drawing, in which:

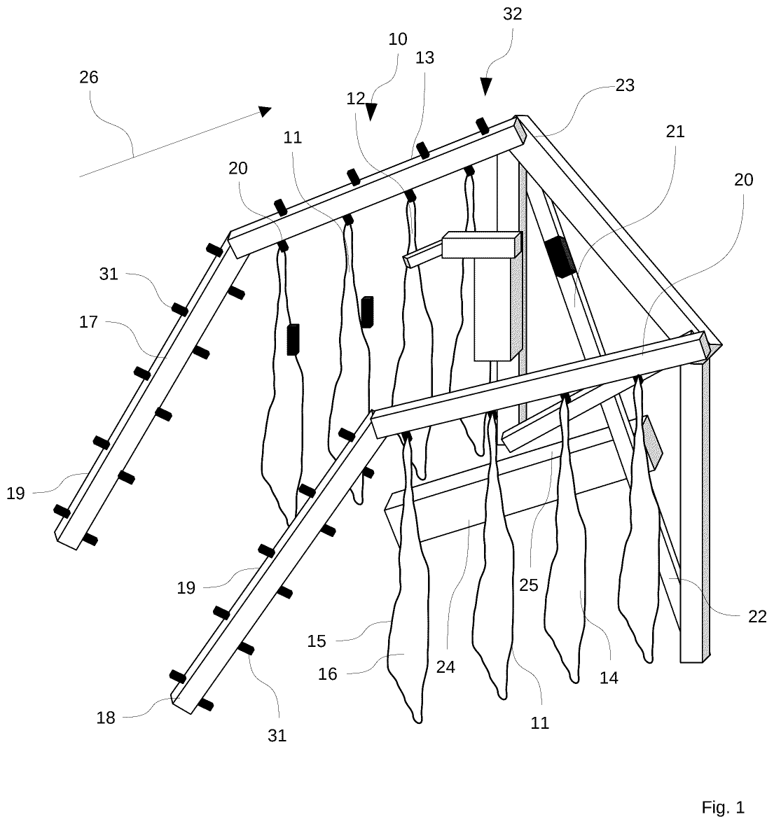

FIG. 1 shows a perspective illustration of an apparatus,

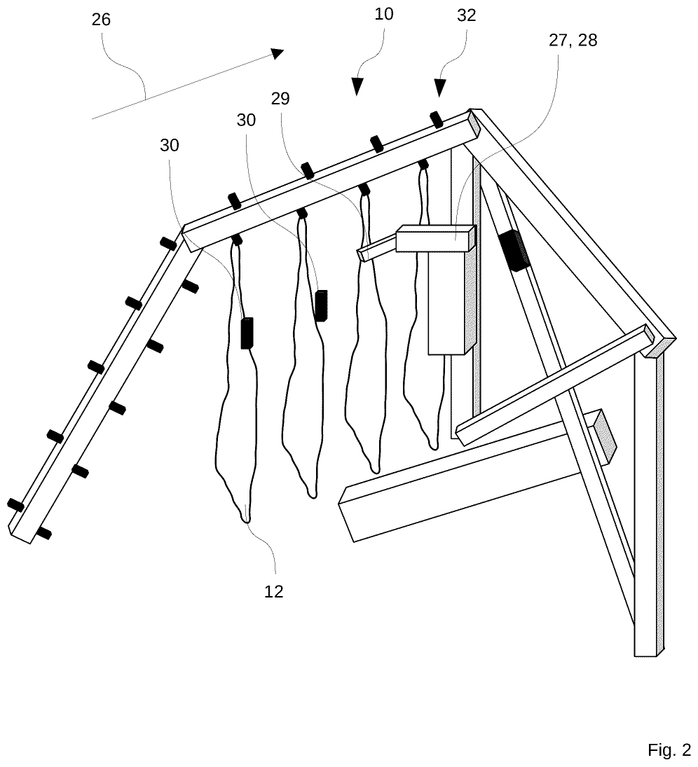

FIG. 2 shows a partial illustration of the apparatus according to FIG. 1,

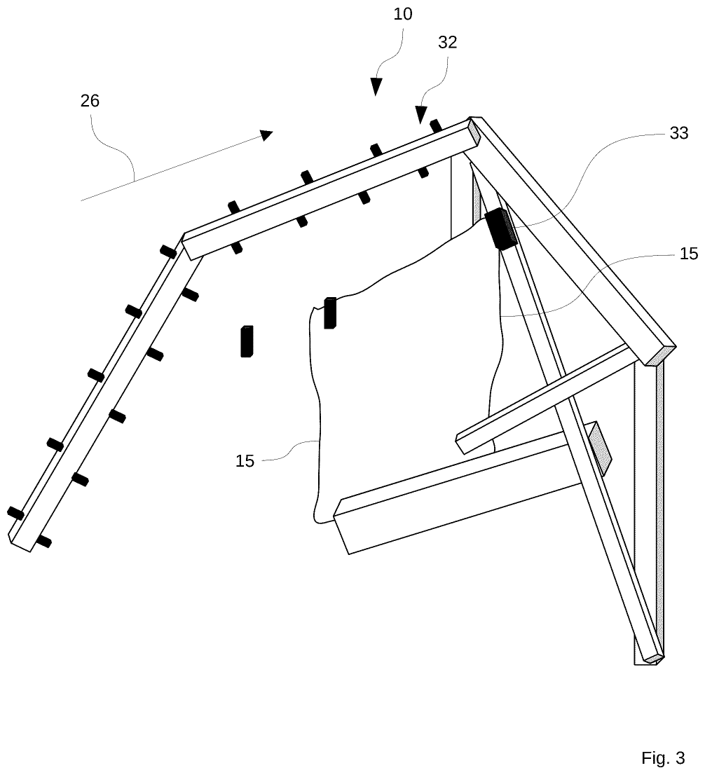

FIG. 3 shows a partial illustration of the apparatus according to FIG. 1 after a further method step, and

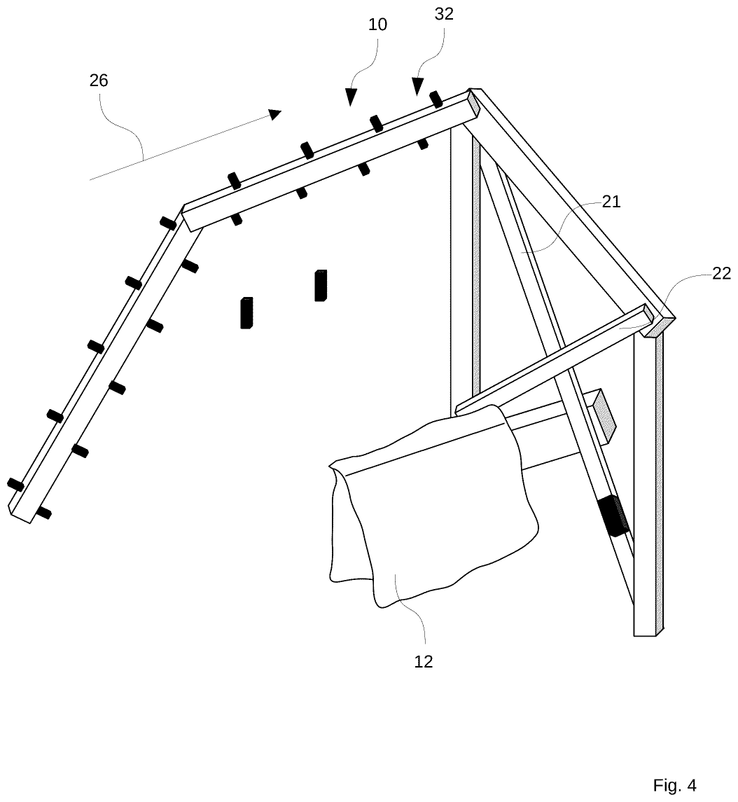

FIG. 4 shows a partial illustration of the apparatus according to FIG. 1 after a last method step.

The apparatus 10 which is reproduced by way of example in the figures serves to feed rectangular textile articles to an intake device. These articles are preferably laundry items or sheets 11, tablecloths or the like. These articles are all of flexurally slack configuration and, in accordance with their rectangular shape, have four corner regions 12 each with a corner 13. The corner regions 12 each form the regions around the corners 13. If a textile article or specifically a sheet 11 is held on a corner region 12, the sheet hangs perpendicularly downward. Here, an adjacent corner region 12 configures a loop 14. This loop 14 is ultimately a folded-over corner region 12. The sheet 11 has an edge or a border 15 between each of the corners 13. On account of the rectangular shape, each sheet 11 has four edges 15. The region which extends slightly from the edges 15 to the sheet 11 is called a border region 16.

On account of the large-area shape of the laundry items or the sheets 11, it has been difficult up to now to feed the sheets at least semi-automatically to an intake device or a treatment device. As a rule, the apparatus 10 described herein is situated between a device for washing the laundry items and an apparatus for further treatment, in particular drying and/or folding. The sheets 11 arrive at the apparatus 10 in a washed and separated state, and are stretched or deposited, with the result that they can be transferred in an advantageous way to a device for further processing of the sheets 11.

The apparatus 10 described herein has substantially a transport system which has two rails 17, 18 in the exemplary embodiment shown in FIGS. 1 to 4. These rails 17, 18 are oriented parallel to one another and consist of two portions, namely a first portion 19 and a second horizontal portion 20. The rails 17, 18 have a multiplicity of clamps 31 which are moved on the rails 17, 18 in a circulating manner by a drive. These clamps 31 are configured in such a way that they can hold and transport a textile article or a sheet 11. To this end, the clamps 31 can be automatically closed and opened. One particular exemplary embodiment can provide that the clamps 31 are configured rotatably on the rails 17, 18 in a targeted manner or can be rotated.

In the exemplary embodiment shown here, the end regions of the second portions 20 are each adjoined by a linear axle 21, 22. These linear axles 21, 22 are oriented diagonally and run from the end of the second portions 20 obliquely downward, with the result that they form an X among one another.

In the exemplary embodiment which is shown here, the rails 17, 18 are oriented perpendicularly with respect to the linear axles 21, 22. It is also conceivable, however, that the rails 17, 18 and the linear axles 21, 22 are oriented in any desired manner or transversely or parallel to one another. The clamps 31 are either merged or transferred directly into the linear axles 21, 22, or the linear axles 21, 22 likewise have clamps or a carriage 33, which are likewise configured to grip laundry items or sheets 11. In the exemplary embodiment which is shown here, the linear axles 21, 22 are arranged or fastened in a frame 23 for stabilization purposes.

In the exemplary embodiment of the apparatus 10 which is shown here, a conveyor 24 which is oriented parallel to the rails 17, 18 is situated between the rails 17, 18. This conveyor 24 has substantially a conveyor belt 25 which can be moved in the transport direction 26. Moreover, this conveyor 25 is positioned in such a way that it leads through a lower open quadrant of the linear axles 21, 22 which are arranged in an X-shape.

A robot 27 with a robot arm 28 is situated between the rails 17, 18. Situated on the robot arm is a gripper 29 which is configured in such a way that it can grip a region, in particular a corner region 12, a loop 14 or an edge region 16, of the textile article or the sheet 11. The robot 27 or the robot arm 28 is of multiaxial configuration, with the result that the gripper 29 can move to any position in three-dimensional space. For improved illustration, the robot 27 in FIGS. 1 and 2 is positioned merely between the rails 17, 18, without it being shown how the robot 27 is fastened. As a rule, the robot 27 is fastened to a ceiling or to a corresponding holder which can in turn be connected to the floor or the frame 23.

Finally, cameras 30 are situated between the rails 17, 18. These cameras 30 can be simple cameras or 3D cameras. It is also conceivable that a plurality of cameras are connected together in such a way that they can depict a three-dimensional image of an object to be recorded. In the exemplary embodiment which is shown here, the cameras 30 are positioned at a certain spacing between the rails 17, 18 in such a way that, as viewed in the transport direction 26, they are positioned in front of the robot 27 and are directed at the laundry items. As a result of this early recording of the individual laundry items or sheets 11, information essential for the control of the robot 27 can already be generated.

Moreover, the apparatus 10 has a controller (not shown). Both the movement of the clamps 31 and of the robot 27 or the gripper 29 are controlled by this controller. In particular, the actuation of the gripper takes place on the basis of the information which is read out from the cameras 30 by the controller. The controller can detect preferred positions on the sheet 11 using a pattern detection means or a neural network, and can move the gripper 29 correspondingly to these positions, in order to grip the laundry item. This preferred position is preferably the loop 14. The method can certainly also provide, however, that the laundry item or the sheet 11 is gripped at a different position.

On the basis of FIGS. 2 to 4, the method for automatically feeding the rectangular textile article or the sheet 11 is to be described in the following text. For improved clarity, the illustration of the second rail has been omitted in FIGS. 2 to 4. The sheets 11 are first of all (this step is not shown) fed to a clamp 31 manually or automatically with a corner region 12, preferably with a corner 13, at a front end of the first portion 19 of the rail 17. The transport system or the rail 17 then moves the sheet 11 hanging on the clamp 31 in the transport direction 26 along the first portion 19 and the second portion 20 to a pull-on position 32. A multiplicity of laundry items or sheets 11 are correspondingly transported along the rail 17 by way of the multiplicity of clamps 31 arranged behind one another. The same also applies of course to the rail 18 (not shown). It is conceivable that the clamps 31 of the two rails 17, 18 run in an offset manner with respect to one another, with the result that the sheets 11 arrive in the pull-on position 32 at different times. This can have a positive effect, in particular, on the further handling of the sheets 11 by means of the robot 27.

While the sheets 11 are transported along the rail 17, they pass one or more cameras 30 one after another. It is conceivable that the transport of the sheets 11 is interrupted briefly, in order that the at least one camera 30 can record the sheet 11. It is likewise conceivable that the sheet 11 is recorded during the transport.

The at least one camera 30 preferably determines a loop 14 of the sheet 11, onto which the gripper 29 is then guided. This takes place in the pull-on position 32 of the sheet 11, that is to say at the very end of the second portion 20. It is likewise also conceivable, however, that this gripping takes place during the transport of the sheet 11 on the rail 17. The robot arm 28 and the gripper 29 pivot the sheet 11 at the gripped loop 14 on a circular path counter to the transport direction 26, with the result that a spacing is formed between the clamp 31, on which the sheet 11 hangs, and the gripper 29. This spacing corresponds precisely to the spacing between the corner region 12 gripped by the clamp 31 and the loop 14 or the gripper 29 at the time of the loop 14 being gripped. By virtue of the fact that the loop 14 is also a corner region 12 and as a result of the circular stretching of the sheet 11, two parallel edges 15 of the sheet 11 are configured to hang downward. This is shown diagrammatically in FIG. 3, the illustration of the robot 27 having been dispensed with here for improved understanding. In the exemplary embodiment which is shown here, the sheet 11 is then stretched parallel to the rail 17 and parallel to the conveyor 24. By virtue of the fact that the gripper moves at a spacing from the clamp which corresponds precisely to the initial spacing between the corner region 12 and the loop 14, the sheet 11 is torn neither from the clamp 31 nor from the gripper 29 during the rising movement. Rather, the sheet 11 is widened to its complete width by this movement.

In the next step, the sheet 11 is then moved downward in a manner which hangs on a clamp 31 or a carriage 33 of the linear axle 21 and the gripper 29 and follows the course of the linear axle 21 parallel to the conveyor 24. Here, the spacing between the gripper 29 and the clamp 31 or the carriage 33 is always kept constant. As a result of this pulling-on operation, the sheet 11 is deposited in its widened state on the conveyor 24 or the conveyor belt 25. As soon as the edges 15 of the sheet 11 lie at least approximately with their center above the conveyor 24, the sheet 11 is released by the gripper 29 and the clamp 31 or the carriage 33. The sheet 11 is now situated on the conveyor 24 and can be fed to the further processing device in the transport direction 26 (FIG. 4).

After this last method step has ended, either a further sheet 11 of the same rail 17 can be deposited over the conveyor or a sheet 11 from the rail 18 can be fed to the conveyor 24 in an alternating manner.

### LIST OF DESIGNATIONS

10 Apparatus
11 Sheet
12 corner region
13 corner
14 Loop
15 Edge
16 Edge region
17 Rail
18 Rail
19 First portion
20 Second portion
21 Linear axle
22 Linear axle
23 Frame
24 Conveyor
25 Conveyor belt
26 Transport direction
27 Robot
28 Robot arm
29 Gripper
30 Camera
31 Clamp
32 Pull-on position
33 Carriage

1. A method for automatically feeding rectangular textile articles to an intake device, wherein a respective separated textile article is gripped on a portion of an edge and is pulled on over a conveyor which transports the textile article to the intake device, wherein the textile article is fed in a hanging manner in a clamp on a corner region to a pull-on position, and an upper loop of the hanging textile article is determined in this pull-on position, a gripper gripping this upper loop and stretching the textile article hanging on the clamp, and the gripper and the clamp pulling the textile article in a synchronized movement over the conveyor conveyor.

2. The method as claimed in claim 1, wherein the one or more spaced apart textile articles are fed to the pull-on position in a hanging manner on a transport system or a gripper of a robot arm.

3. The method as claimed in claim 1. wherein the textile article is recorded by one or two or more cameras, and the upper loop of the hanging article is determined, an algorithm for pattern detection being used to this end.

4. The method as claimed in claim 3, wherein, for the case where no upper loop is detected by the camera, the article or the clamp hanging in the rail, is rotated about a horizontal axis by ±45°, ±90° or ±180°, until an upper loop is detected.

5. The method as claimed in claim 1, wherein the gripper is moved automatically by a robot arm onto the loop to be gripped.

6. The method as claimed in claim 1, wherein the robot arm with the gripper carries out a movement which stretches the article, the movement taking place in such a way that two edges or borders of the article are oriented at least approximately parallel to one another.

7. The method as claimed in claim 6, wherein the gripper with the gripped article is moved on a circular path, the radius of this circular path being formed by the spacing between the clamp and the gripper.

8. The method as claimed in claim 6. wherein the article is stretched by the robot arm with the gripper parallel to a transport direction of the conveyor into a stretched state, the two at least approximately parallel edges or borders being oriented transversely, and a lower border or a lower edge of the article being oriented at least approximately parallel to the transport direction of the conveyor.

9. The method as claimed in claim 6, wherein the article is stretched by the robot arm with the gripper parallel to a transport direction of the conveyor into a stretched state, while the clamp is already moved on a linear axle in the direction of the conveyor and, during this movement, the two edges are oriented at least approximately parallel to one another and transversely, and a lower edge is oriented at least approximately parallel to the transport direction of the conveyor.

10. The method as claimed in claim 8, wherein the article is deposited from the stretched state by the clamp and the gripper over the conveyor, the clamp being moved on a linear axle and the gripper being moved by the robot arm without the relative position between the clamp and the gripper being changed.

11. The method as claimed in claim 1, wherein the clamp and the gripper release the article as soon as a center of one of the edges lies above the conveyor.

12. The method as claimed in claim 1, wherein articles which hang on clamps on two transport systems are gripped in a temporally offset manner by at least one gripper and are deposited from opposite sides of the conveyor over the latter in the described way.

13. The method as claimed in claim 12, wherein the clamps on the two transport systems move in a completely asynchronous manner with respect to one another, the movement of the clamps depending on the recording of the cameras and/or on whether articles hang on the clamps or not and/or on the inherent movement of the articles.

14. An apparatus for feeding rectangular textile articles to an intake device, according to method as claimed in claim 1, it being possible for a respective separated textile article which hangs on a clamp to be gripped on a portion of an edge and to be pulled over a conveyor which transports the textile article to the intake device, distinguished by a transport system which has at least one rail or at least one robot and on which the clamp can be moved in order to convey the textile articles to a pull-on position, by at least one gripping system with a gripper for gripping a loop of the textile article in a targeted manner and for stretching and pulling on the article, and by a camera system for determining the loop, and by at least one linear axel, along which the clamp can be moved in a synchronized manner with the gripper, it being possible for the article to be transported in a stretched state between the clamp and the gripper.

15. The apparatus as claimed in claim 14, wherein the transport system has two parallel rails, on which clamps for conveying the textile articles are arranged and can be conveyed, and/or a robot with a robot arm, on which a gripper for conveying the textile articles is arranged and can be conveyed.

16. The apparatus as claimed in claim 14, distinguished by at least one or two or more cameras for recording an upper loop of the hanging article, the at least one camera being connected to a processor for image reconciliation.

17. The apparatus as claimed in claim 14, wherein the clamp which hangs in the rail is mounted rotatably by ±45°, ±90° or ±180°, and the rotation takes place automatically or on the basis of a changing friction or a braking operation.

18. The apparatus as claimed in claim 14, wherein the gripper is arranged on a robot arm, and this robot arm assigned to one, two or more rails.

19. The apparatus as claimed in claim 14, wherein the robot arm is arranged between two mails rails, with the result that the robot arm can operate the two rails in an alternating manner and can grip and stretch, in an alternating manner, the textile articles which hang on different rails.
